(19) United States
(12) Patent Application Publication
(10) Pub. No.: US 2007/0091027 A1
(43) Pub. Date: Apr. 26, 2007

(54) Plasma display device, driving apparatus and driving method thereof

(76) Inventor: Sang-Shin Kwak, Yongin-si (KR)

Correspondence Address: CHRISTIE, PARKER & HALE, LLP, PO BOX 7068, PASADENA, CA, 91109-7068, US

(21) Appl. No.: 11/583,393

(22) Filed: Oct. 18, 2006

(30) Foreign Application Priority Data
Oct. 25, 2005 (KR) 10-2005-0100681
Dec. 8, 2005 (KR) 10-2005-0119491

(51) Int. Cl. G09G 3/28

(52) U.S. Cl. 345/68

(57) ABSTRACT

A plasma display device, a driving apparatus and a driving method is provided. The display device includes a plurality of electrodes, a first transistor is coupled to a power source, and a second transistor coupled between the first transistor and a second power source. A first capacitor is coupled to the first transistor and the second transistor, a second capacitor is coupled to the first capacitor, and a diode is coupled between the first power source and the second capacitor. The third transistor and the fourth transistor are coupled to each other in a back-to-back manner, and are coupled in series with an inductor. A fifth transistor is coupled between the second capacitor and one or more of the electrodes, and a sixth transistor is coupled between the first capacitor and one or more of the electrodes.

### CROSS-REFERENCES TO RELATED APPLICATION

This application claims priority to and the benefit of Korean Patent Application No. 10-2005-0100681 filed on Oct. 25, 2005 and Korean Patent Application No. 10-2005-0119491 filed on Dec. 08, 2005 in the Korean Intellectual Property Office, the entire contents of which are incorporated herein by reference.

### BACKGROUND OF THE INVENTION

(a) Field of the Invention

The present invention relates to a plasma display device, a driving apparatus and a driving method thereof. More particularly, the present invention relates to an energy recovery circuit of a plasma display device, a driving apparatus and a driving method thereof.

(b) Description of the Related Art

A plasma display device is a flat panel display that uses plasma generated by a gas discharge process to display characters or images. It includes a plurality of discharge cells arranged in a matrix pattern. In general, one frame of the PDP is divided into a plurality of subfields, and each subfield includes a reset period, an address period, and a sustain period. Turn-on/turn-off cells (i.e., cells to be turned on or off) are selected during the address period of each subfield, and a sustain discharge operation is performed on the turn-on cells so as to display an image during the sustain period.

Since a high level voltage and a low level voltage are alternately applied to an electrode on which the sustain discharge operation is performed during the sustain period, a voltage of a transistor for applying the high and low voltages is required to correspond to a difference between the high level and the low level. Accordingly, the cost of a sustain discharge circuit is increased due to the high voltage of the transistor.

### SUMMARY OF THE INVENTION

A plasma display device according to an exemplary embodiment of the present invention includes a plurality of first electrodes, a first transistor, a second transistor, a first capacitor, a second capacitor, a charging path, an inductor, a third transistor, a fourth transistor, a fifth transistor, and a sixth transistor. The first transistor has a first terminal electrically coupled to a first power source for supplying a first voltage. The second transistor has a first terminal electrically coupled to a second terminal of the first transistor and a second terminal electrically coupled to a second power source for supplying a second voltage. The first capacitor is charged with a third voltage, and has a first terminal electrically coupled to a node of the first transistor and the second transistor. The second capacitor is charged with a fourth voltage, and has a first terminal electrically coupled to a second terminal of the first capacitor. The charging path is electrically coupled between the first power source and a second terminal of the second capacitor. The inductor, the third transistor, and the fourth transistor are electrically coupled in series to each other between the second terminal of the first capacitor and the plurality of first electrodes. The fifth transistor is electrically coupled between the second terminal of the second capacitor and the plurality of first electrodes. The sixth transistor is electrically coupled between the plurality of first electrodes and the first terminal of the first capacitor. The exemplary plasma display device further includes a controller for setting the second and sixth transistors to be turned on during a first period, setting the second and third transistors to be turned on during a second period, setting the second and fifth transistors to be turned on during a third period, setting the first and third transistors to be turned on during a fourth period, setting the first and fifth transistors to be turned on during a fifth period, setting the first and fourth transistors to be turned on during a sixth period, setting the second and fifth transistors to be turned on during a seventh period, and setting the second and fourth transistors to be turned on during an eighth period.

An exemplary driving method according to an embodiment of the present invention is to drive a plasma display device including a first electrode and a second electrode. In the exemplary driving method, a voltage at the first electrode is increased by supplying energy stored in a first capacitor that is charged with a first voltage to the first electrode through an inductor electrically coupled to the first electrode, a third voltage corresponding to a sum of the first voltage and a second voltage is applied to the first electrode through a first capacitor and a second capacitor that are charged with the second voltage, the voltage at the first electrode is increased by supplying a first power source for supplying a fourth voltage and the energy stored in the first capacitor to the first electrode through the inductor, a fifth voltage corresponding to a sum of the third voltage and the fourth voltage is applied to the first electrode through the first power source and the first and second capacitors, the voltage at the first electrode is decreased by recovering the energy stored in the first electrode to the first capacitor and the first power source through the inductor, the third voltage is applied to the first electrode through the first and second capacitors, the voltage at the first electrode is decreased by recovering the energy stored in the first electrode to the first capacitor through the inductor, and a sixth voltage that is lower than the fourth voltage is applied to the first electrode.

An exemplary driving apparatus according to an embodiment of the present invention drives a plasma display device including a first electrode and a second electrode. The exemplary driving apparatus includes a first capacitor, a second capacitor, a first transistor, a second transistor, an inductor, a first resonance path, a second resonance path, and a switching unit. The first capacitor is charged with a first voltage. The second capacitor is charged with a second voltage and has a first terminal electrically coupled to a first terminal of the first capacitor. The first transistor is electrically coupled between a second terminal of the first capacitor and the first electrode. The second transistor is electrically coupled between a second terminal of the second capacitor and the first electrode. The inductor is electrically coupled between a node of the first capacitor and the second capacitor and the plurality of first electrodes. The first resonance path is formed between the node and the plurality of first electrodes, and increases a voltage at the first electrode by a resonance. The second resonance path is formed between the node and the plurality of first electrodes, and decreases the voltage at the first electrode by the resonance. The switching unit selectively applies a third voltage and a fourth voltage that is lower than the third voltage to the second terminal of the second capacitor. In this case, the voltage at the first electrode is increased through the first resonance path while the fourth voltage is applied to the second terminal of the second capacitor, a fifth voltage corresponding to a sum of the fourth voltage, the first voltage, and the second voltage is applied to the first electrode by turning on the first transistor while the fourth voltage is applied to the second terminal of the second capacitor, the voltage at the first electrode is increased through the first resonance path while the third voltage is applied to the second terminal of the second capacitor, a sixth voltage corresponding to a sum of the third voltage, the first voltage, and the second voltage is applied to the first electrode by turning on the first transistor while the third voltage is applied to the second terminal of the second capacitor, the voltage at the first electrode is decreased through the second resonance path while the third voltage is applied to the second terminal of the second capacitor, the first voltage is applied to the first electrode by turning on the first transistor while the fourth voltage is applied to the second terminal of the second capacitor, the voltage at the first electrode is decreased through the second resonance path while the fourth voltage is applied to the second terminal of the second capacitor, and the fourth voltage is applied to the first electrode by turning on the second transistor while the fourth voltage is applied to the second terminal of the second capacitor.

### BRIEF DESCRIPTION OF THE DRAWINGS

FIG. 1 shows a schematic diagram of a plasma display device according to an exemplary embodiment of the present invention.

FIG. 2 shows a sustain pulse waveform according to a first exemplary embodiment of the present invention.

FIG. 3 shows a schematic diagram of a sustain discharge circuit according to the first exemplary embodiment of the present invention.

FIG. 4 shows a signal timing diagram of the sustain discharge circuit according to the first exemplary embodiment of the present invention.

FIGS. 5A, 5B, 5C, 5D, 5E, 5F, 5G and 5H show diagrams of the operations of the sustain discharge circuit shown in FIG. 3 according to signal timings shown in FIG. 4.

FIG. 6 shows a sustain pulse waveform according to a second exemplary embodiment of the present invention.

FIG. 7 shows a schematic diagram of a sustain discharge circuit according to the second exemplary embodiment of the present invention.

### DETAILED DESCRIPTION

As used herein, the phrase “maintained at a predetermined voltage” should not be understood as “maintained exactly at a predetermined voltage”. To the contrary, even if a voltage difference between two points varies, the voltage difference is “maintained at a predetermined voltage” when the variance is within a range allowed in design constraints or when the variance is caused due to a parasitic component that is usually disregarded by a person of ordinary skill in the art. A threshold voltage of a semiconductor device (e.g., a transistor, a diode or the like) may be very low in comparison with a discharge voltage, and therefore the threshold voltage may be approximated to approximately 0V in the following description.

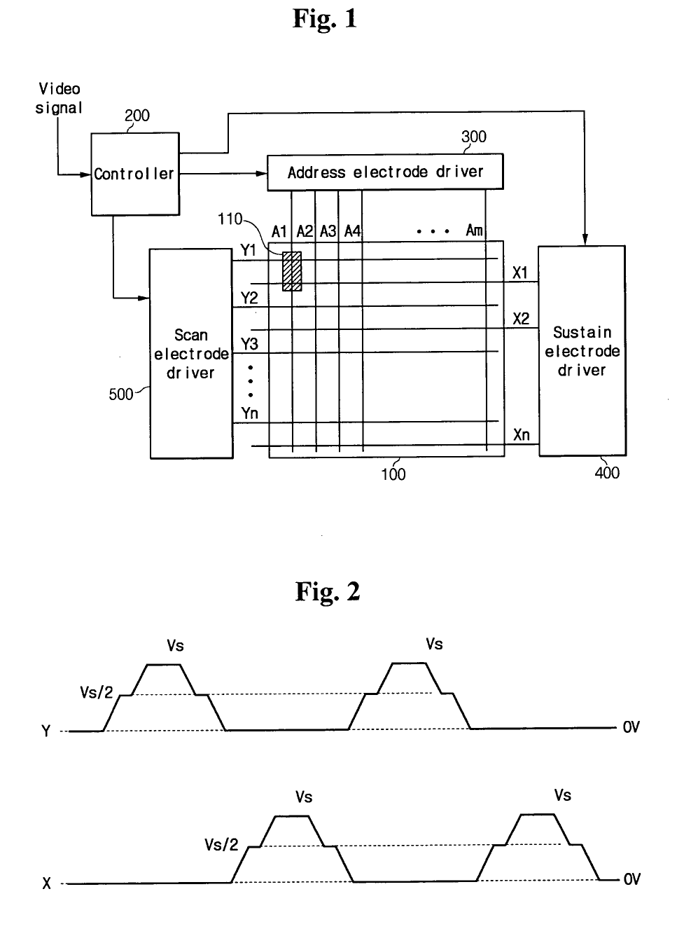

As shown in FIG. 1, the plasma display device according to the exemplary embodiment of the present invention includes a plasma display device panel (PDP) 100, a controller 200, and an address electrode driver 300, a sustain electrode driver 400, and a scan electrode driver 500.

The PDP 100 includes a plurality of address electrodes A1 to Am (hereinafter, referred to as “A electrodes”) extending in a column direction, and a plurality of sustain electrodes and a plurality of scan electrodes, X1 to Xn and Y1 to Yn, respectively (hereinafter, referred to as “X electrodes” and “Y electrodes,” respectively) extending in a row direction by pairs. In general, the X electrodes X1 to Xn correspond to the Y electrodes Y1 to Yn, and the Y electrodes and the X electrodes Y1 to Yn and X1 to Xn, respectively, are arranged to cross the A electrodes A1 to Am. In this case, a discharge space on a crossing region of the A electrodes A1 to Am and the X and Y electrodes X1 to Xn and Y1 to Yn forms a discharge cell 110.

The controller 200 receives an external image signal (e.g., a video image signal), outputs a driving control signal, divides a frame into a plurality of subfields each having a brightness weight value, and drives each subfield. Each subfield has an address period and a sustain period. The A, X, and Y electrode drivers 300, 400, and 500, respectively, apply a driving voltage to the A electrodes A1 to Am, the X electrodes X1 to Xn, and the Y electrodes Y1 to Yn in response to the driving control signals from the controller 200.

In further detail, during the address period of each subfield, the A, X, and Y electrode drivers 300, 400, and 500, respectively, select the turn-on discharge cell and the turn-off discharge cell from among a plurality of discharge cells 110. Referring to FIG. 2, during the sustain period of each subfield, the sustain electrode driver 400 (hereinafter, also referred to as the “X electrode driver 400”) applies a sustain pulse alternately having a high level voltage (Vs) and a low level voltage (approximately 0V) to the plurality of X electrodes X1 to Xn a number of times corresponding to a weight value of the corresponding subfield. The scan electrode driver 500 (hereinafter, also referred to as the “Y electrode driver 500”) applies the sustain pulse having a reverse phase of the sustain pulse applied to the X electrodes X1 to Xn, to the plurality of Y electrodes Y1 to Yn. Accordingly, a voltage difference between the Y electrodes and the X electrodes is alternately a Vs voltage and a −Vs voltage, and the sustain discharge is repeatedly generated on the turn-on discharge cell a predetermined number of times. As shown in FIG. 2, while the sustain pulse according to the first exemplary embodiment of the present invention is increased from the low level voltage (approximately 0V) to the high level voltage (Vs) and is decreased from the high level voltage (Vs) to the low level voltage (approximately 0V), it stops increasing and it stops decreasing at an intermediate level voltage (Vs/2) for a predetermined time.

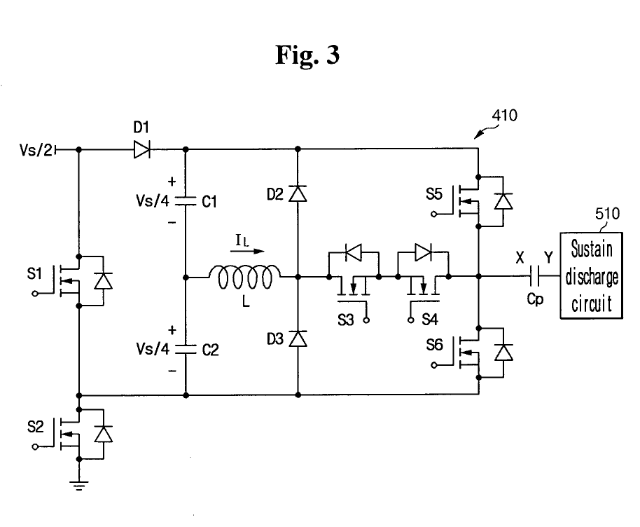

A sustain discharge circuit for supplying the sustain pulse shown in FIG. 2 will now be described with reference to FIGS. 3, 4, 5A, 5B, 5C, 5D, 5E, 5F, 5G and 5H.

FIG. 3 shows a circuit diagram of a sustain discharge circuit 410 according to the first exemplary embodiment of the present invention. For better understanding and ease of description, the sustain discharge circuit 410 coupled to the plurality of X electrodes X1 to Xn is only illustrated in FIG. 3, and the sustain discharge circuit 410 is formed in the X electrode driver 400 shown in FIG. 1. In one embodiment, a sustain discharge circuit 510 coupled to the plurality of Y electrodes Y1 to Yn may have the same configuration as the sustain discharge circuit 410 in FIG. 3 or it may have another configuration that is different from the configuration of the sustain discharge circuit 410 shown in FIG. 3.

In one embodiment, the sustain discharge circuit 410 may be commonly coupled to the plurality of X electrodes X1 to Xn. In another embodiment, it may be coupled to some of the plurality of X electrodes X1 to Xn. In addition, for better understanding and ease of description, one X electrode, X, and one Y electrode, Y, are illustrated and a capacitance formed by X and Y is illustrated as a panel capacitor Cp.

Referring to FIG. 3, the sustain discharge circuit 410 according to the first exemplary embodiment of the present invention includes transistors S1, S2, S3, S4, S5, and S6, diodes D1, D2, and D3, an inductor L, and capacitors C1 and C2. In this embodiment, the transistors S1, S2, S3, S4, S5, and S6 are each an n-channel field effect transistor, particularly, an n-channel metal oxide semiconductor transistor (NMOS). Additionally, a body diode is formed in the transistors S1, S2, S3, S4, S5, and S6 in a direction from a source of the respective transistor toward a drain of the respective transistor. In other embodiments, other transistors that can perform a similar function may be used for the transistors S1, S2, S3, S4, S5, and S6. The transistors S1, S2, S3, S4, S5, and S6 are each illustrated as one transistor in FIG. 3. In other embodiments, the transistors S1, S2, S3, S4, S5, and S6 may include a plurality of transistors coupled in parallel to each other.

A drain of the transistor S1 is coupled to a power source Vs/2 for supplying a Vs/2 voltage corresponding to a half of a difference between the high level voltage (Vs) and the low level voltage (approximately 0V). In this case, the power source Vs/2 may be provided by a capacitor coupled to an output terminal of a switching mode power supply (SMPS, not shown). A source of the transistor S1 is coupled to the drain of the transistor S1, and a source of the transistor S2 is coupled to a ground terminal supplying a low level voltage (i.e., a ground voltage approximately 0V). A first terminal of the capacitor C2 is coupled to the source of the transistor S1 and a drain of the transistor S2, and a second terminal of the capacitor C2 is coupled to a first terminal of the capacitor C1. A second terminal of the capacitor C1 is coupled to a cathode of the diode D1, and an anode of the diode D1 is coupled to the power source Vs/2. In this case, the diode D1 forms a charging path for charging the respective capacitors C1 and C2 to a Vs/4 voltage when the transistor S2 is turned on, and the capacitors C1 and C2 are respectively charged to the Vs/4 voltage through the charging path. Rather than using the diode D1, other elements (e.g., a transistor) for forming the charging path may be used. In addition, capacitances of the capacitors C1 and C2 are selected as equal so as to charge the respective capacitors C1 and C2 to the Vs/4 voltage. The two transistors S1 and S2 operate as switching units for selectively applying the Vs/2 voltage and the approximately 0V voltage to the first terminal of the capacitor C2.

The X electrode is coupled to a source of the transistor S5, a drain of the transistor S6, and a drain of the transistor S4, a drain of the transistor S5 is coupled to the second terminal of the capacitor C1, and a source of the transistor S6 is coupled to a node of the transistors S1 and S2 and the capacitor C2. A first terminal of the inductor L is coupled to the second terminal of the capacitor C2, a drain of the transistor S3 is coupled to a second terminal of the inductor L, a source of the transistor S3 is coupled to a source of the transistor S4, and the drain of the transistor S4 is coupled to the X electrode. In this case, since the sources of the transistors S3 and S4 are coupled to each other, when the transistors S3 and S4 are turned off the transistors S3 and S4 prevent a current path from being formed by a body diode. That is, the transistors S3 and S4 are coupled in a back-to-back manner. In addition, since a resonance path for charging and discharging may be formed when the inductor L and the transistors S3 and S4 are coupled in series between the second terminal of the capacitor C2 and the X electrode in FIG. 3, positions thereof may be changed with each other.

An anode and a cathode of the diode D2 are respectively coupled to the second terminal of the inductor L and the second terminal of the capacitor C1, and an anode and a cathode of the diode D3 are respectively coupled to the first terminal of the capacitor C2 and the second terminal of the inductor L. The diodes D2 and D3 perform a free-wheeling operation for currents remaining in the inductor L, and recover remaining energy to the capacitors C1 and C2.

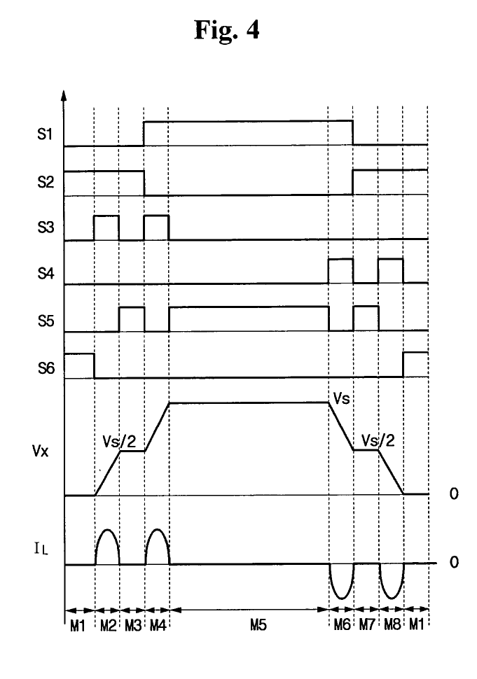

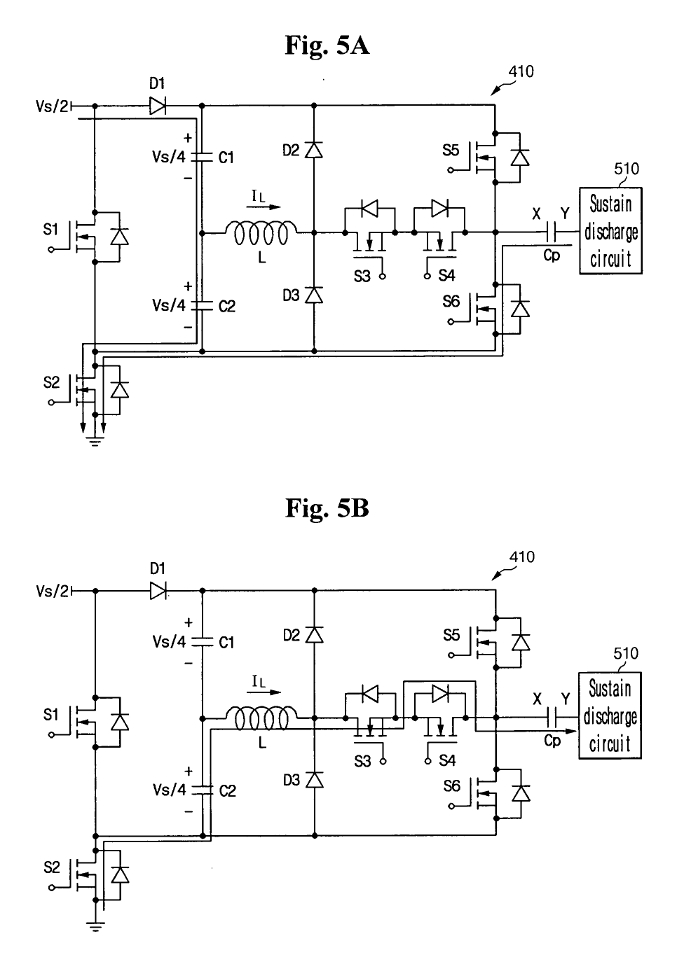

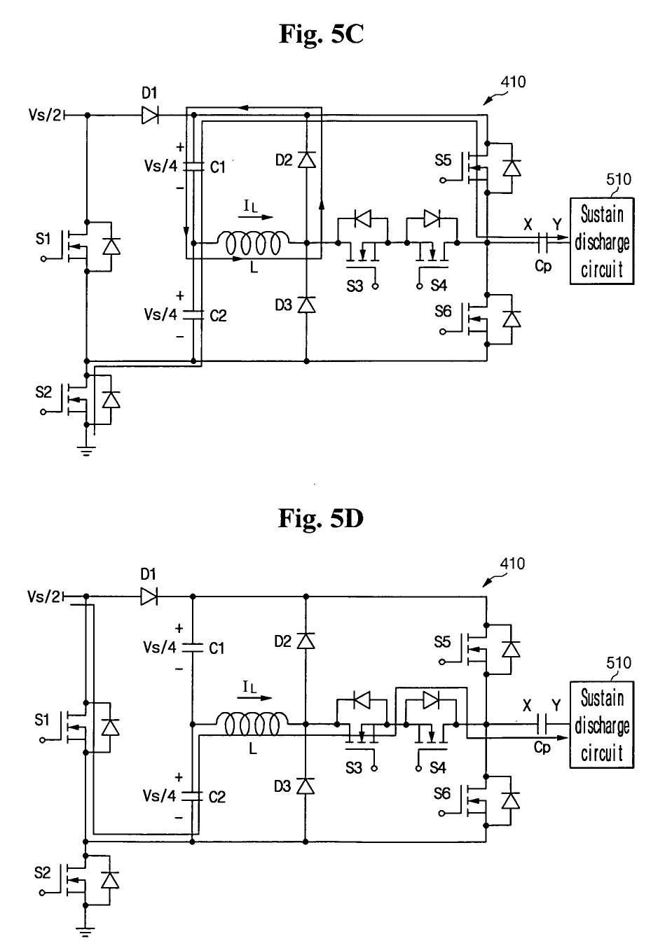

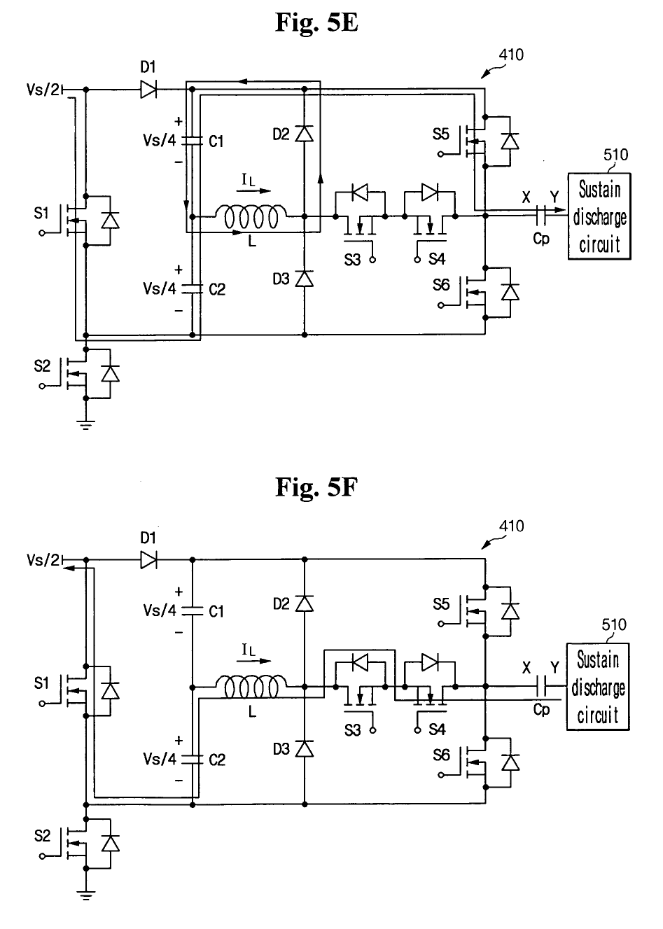

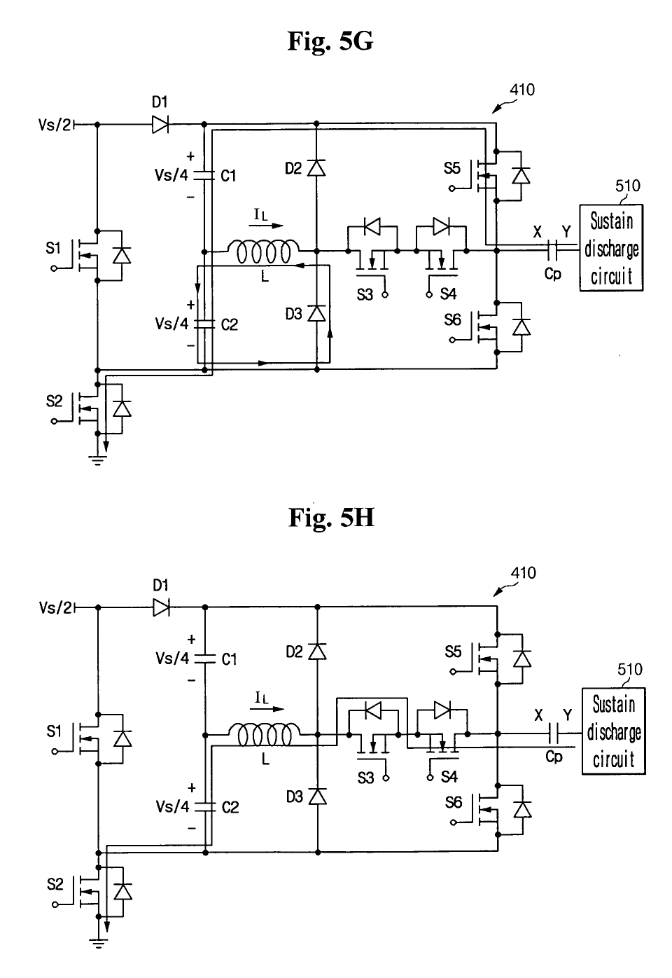

An operation of the sustain discharge circuit 410 shown in FIG. 3 will now be described with reference to FIG. 4 and FIGS. 5A, 5B, 5C, 5D, 5E, 5F, 5G and 5H.

FIG. 4 shows a signal timing diagram of the sustain discharge circuit 410 according to the first exemplary embodiment of the present invention, and FIGS. 5A, 5B, 5C, 5D, 5E, 5F, 5G and 5H show diagrams representing operations of the sustain discharge circuit 410 shown in FIG. 3 according to signal timings shown in FIG. 4.

Referring to FIG. 4 and FIG. 5A, since the transistors S2 and S6 are turned on at a mode M1, the approximately 0V voltage is applied to the X electrode through a path of the X electrode, the transistor S6, the transistor S2, and the ground terminal as shown in FIG. 5A. In addition, as shown in FIG. 5A, the capacitors C1 and C2 are respectively charged with the Vs/4 voltage through a path of the power source Vs/2, the diode D1, the capacitors C1 and C2, the transistor S2, and the ground terminal. In this case, since voltages at the drains of the transistors S2 and S6 are the approximately 0V voltage and voltages at the drains of the transistors S1 and S5 are the Vs/2 voltage, a voltage that is lower than the Vs/2 voltage is applied between the drain and the source of the turned-off transistors S1, S3, S4, and S5. That is, the transistors S1, S3, S4, and S5 having the Vs/2 voltage may be used.

At a mode M2, since the transistor S3 is turned on and the transistor S6 is turned off while the transistor S2 is turned on, a resonance is generated through a path of the ground terminal, the transistor S2, the capacitor C2, the inductor L, the transistor S3, and a body diode of the transistor S4, and the panel capacitor Cp as shown in FIG. 5B. By the resonance, the energy charged to the capacitor C2 is provided to the X electrode through the inductor L, and a voltage Vx at the X electrode is increased from the approximately 0V voltage to the Vs/2 voltage.

At a mode M3, since the transistor S5 is turned on and the transistor S3 is turned off while the transistor S2 is turned on, the Vs/2 voltage is applied to the X electrode X through a path of the ground terminal, the transistor S2, the capacitors C2 and C1, and the transistor S5 as shown in FIG. 5C. In this case, the capacitor C1 and the capacitor C2 are coupled in series, the approximately 0V is applied to the first terminal of the capacitor C2, a voltage at the second terminal of the capacitor C1 becomes the Vs/2 voltage, and therefore the Vs/2 voltage is applied to the X electrode. As shown in FIG. 5C, when a current I_{L} remains in the inductor L after increasing the voltage at the X electrode to the Vs/2 voltage at the mode M2, the remaining current I_{L} is freewheeled through the inductor L, the diode D2, and the capacitor C1. That is, the energy remaining in the inductor L is recovered to the capacitor C1. In this case, since the voltage at the drain of the transistor S2 is the approximately 0V voltage and the voltage at the drain of the transistor S5 is the Vs/2 voltage, the voltage that is lower than the Vs/2 voltage is applied between the drain and the source of the turned-off transistors S1, S3, S4, and S6. That is, the transistors S1, S3, S4, and S6 having the Vs/2 voltage may be used.

At a mode M4, since the transistors S2 and S5 are turned off and the transistors S1 and S3 are turned on, the resonance is generated through a path of the power source Vs/2, the transistor S1, the capacitor C2, the inductor L, the transistor S3, the body diode of the transistor S4, and the panel capacitor Cp as shown in FIG. 5D. By the resonance, the energy charged to the power source Vs/2 and capacitor C1 is provided to the X electrode through the inductor L, and the voltage Vx at the X electrode is increased. In this case, since the power source Vs/2 and the capacitor C2 are coupled in series and a voltage at the second terminal of the capacitor C2 becomes a 3 Vs/4 voltage, the voltage Vx at the X electrode is increased from the Vs/2 voltage to the Vs voltage.

At a mode M5, since the transistor S5 is turned on and the transistor S3 is turned off while the transistor S1 is turned on, the Vs voltage is applied to the X electrode X through a path of the power source Vs/2, the transistor S1, the capacitors C2 and C1, and the transistor S5 as shown in FIG. 5E. In this case, the power source Vs and the capacitors C1 and C2 are coupled in series, the voltage at the second terminal of the capacitor C1 becomes the Vs voltage, and therefore the Vs voltage is applied to the X electrode. As shown in FIG. 5E, when the current I_{L} remains in the inductor L after the voltage at the X electrode is increased to the Vs voltage at the mode M4, the current I_{L} remaining in the inductor L is freewheeled through the diode D2 and the capacitor C1. That is, the energy remaining in the inductor L is recovered to the capacitor C1. In this case, since the voltage at the drain of the transistor S2 is the Vs/2 voltage and a voltage at the drain of the transistor S6 is the Vs voltage, the voltage that is lower than the Vs/2 voltage is applied between the drain and source of the turned-off transistors S2, S3, S4, and S6. That is, the transistors S2, S3, S4, and S6 having the Vs/2 voltage may be used.

At a mode M6, since the transistor S5 is turned off and the transistor S4 is turned on while the transistor remains to be turned on, the resonance is generated through a path of the panel capacitor Cp, the transistor S4, the body diode of the transistor S3, the inductor L, the capacitor C2, the transistor S1, and the power source Vs/2 as shown in FIG. 5F. By the resonance, the voltage at the X electrode is decreased from the Vs voltage to the Vs/2 voltage while the energy stored in the panel capacitor Cp is recovered to the capacitor C2 and the power source Vs/2 through the inductor L. In this case, since the power source Vs/2 and the capacitor C2 are coupled in series to supply a 3 Vs/4 voltage, the voltage Vx at the X electrode is decreased from the Vs voltage to the Vs/2 voltage.

At a mode M7, since the transistors S2 and S5 are turned on and the transistors S1 and S4 are turned off, the Vs/2 voltage is applied to the X electrode X through a path of the X electrode, the transistor S5, the capacitors C1 and C2, the transistor S2, and the ground terminal as shown in FIG. 5G. In this case, the capacitor C1 and the capacitor C2 are coupled in series, the voltage at the second terminal of the capacitor C1 becomes the Vs/2 voltage, and therefore the Vs/2 voltage is applied to the X electrode. In addition, when the current I_{L} remains in the inductor L after the voltage at the X electrode is decreased to the Vs/2 voltage at the mode M6 as shown in FIG. 5G, the current I_{L} remaining in the inductor L is freewheeled through the inductor L, the capacitor C2, and the diode D3. That is, the energy remaining in the inductor L is recovered to the capacitor C2. In this case, since the voltage at the drain of the transistor S2 is the approximately 0V voltage and the voltage at the drain of the transistor S6 is the Vs/2 voltage, the voltage that is lower than the Vs/2 voltage is applied between the drain and the source of the turned-off transistors S1, S3, S4, and S6. That is, the transistors S1, S3, S4, and S6 having the Vs/2 voltage may be used.

At a mode M8, since the transistor S5 is turned off and the transistor S4 is turned on while the transistor S2 is turned on, the resonance is generated through a path of the panel capacitor Cp, the transistor S4, the body diode of the transistor S3, the inductor L, the capacitor C2, the transistor S2, and the ground terminal as shown in FIG. 5H. By the resonance, since the energy stored in the panel capacitor Cp is recovered to the capacitor C2 through the inductor L, the voltage at the X electrode is decreased from the Vs/2 voltage to the approximately 0V voltage. In this case, the first terminal of the capacitor C2 is coupled to the ground terminal, the capacitor C2 supplies the Vs/4 voltage, and therefore the voltage Vx at the X electrode is decreased from the Vs/2 voltage to the approximately 0V voltage.

As described, according to the first exemplary embodiment of the present invention, the Vs voltage and the approximately 0V voltage are alternately applied to the X electrode since the modes M1, M2, M3, M4, M5, M6, M7 and M8 are repeatedly performed a number of times corresponding to a weight value of a corresponding subfield during the sustain period. In addition, since the voltage Vx at the X electrode is increased from the Vs/2 voltage to the Vs voltage after being increased from approximately 0V to the Vs/2 voltage and it is decreased from the Vs/2 voltage to the approximately 0V voltage after being decreased from the Vs voltage to the Vs/2 voltage, an electro-magnetic interference (EMI) may be reduced compared to when the voltage Vx at the X electrode is directly increased from the approximately 0V voltage to the Vs voltage and it is directly decreased from the Vs voltage to the approximately 0V voltage.

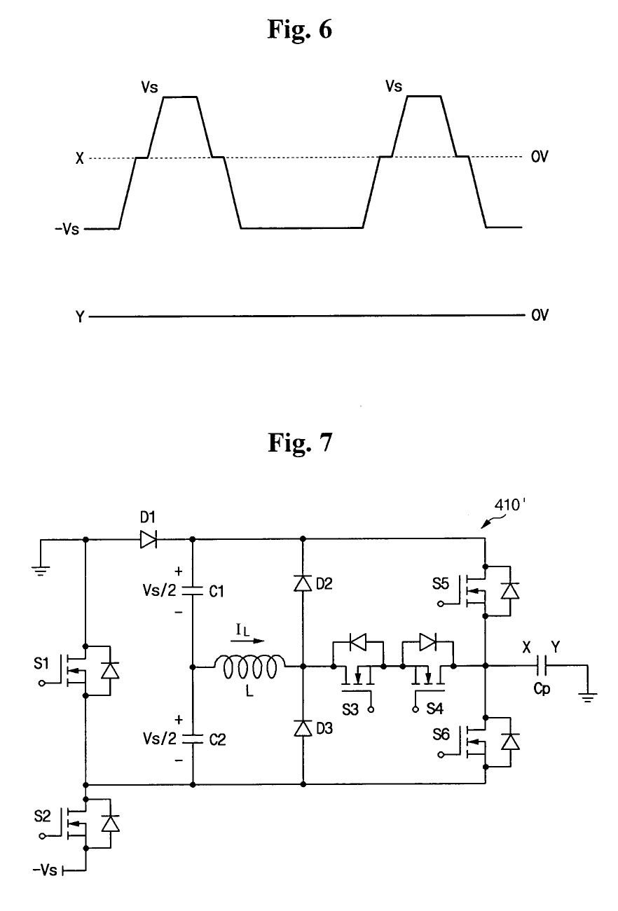

While it has been described that the sustain pulse alternately has the high level voltage and the low level voltage and the sustain pulses of reverse phases are respectively applied to the X electrode and the Y electrode in the first exemplary embodiment of the present invention, the sustain pulse may be applied to one of the X electrode and the Y electrode, which will be described with reference to FIG. 6 and FIG. 7.

FIG. 6 shows a diagram representing a sustain pulse according to a second exemplary embodiment of the present invention, and FIG. 7 shows a circuit diagram of a sustain discharge circuit 410′ according to the second exemplary embodiment of the present invention.

As shown in FIG. 6, a sustain pulse alternately having the Vs voltage and a −Vs voltage is applied to the plurality of X electrodes X1 to Xn during the sustain period according to the second exemplary embodiment of the present invention, and the approximately 0V voltage is applied to the plurality of Y electrodes Y1 to Yn. When the voltage at the X electrode is increased from the −Vs voltage to the Vs voltage and is decreased from the Vs voltage to the −Vs voltage, it stops being increased at the approximately 0V voltage which is an intermediate level voltage of the Vs voltage and the −Vs voltage for a predetermined time. Accordingly, a voltage difference between the X and Y electrodes alternately becomes the Vs voltage and the −Vs voltage in a like manner of the sustain pulse shown in FIG. 2.

As shown in FIG. 7, the sustain discharge circuit 410′ according to the second exemplary embodiment of the present invention is largely similar to that of the first exemplary embodiment of the present invention, except for a voltage supplied by a power source and a voltage charged to the capacitors C1 and C2. The drain of the transistor S1 is coupled to the ground terminal, and the source of the transistor S2 is coupled to a power source −Vs for supplying the −Vs voltage. Accordingly, the −Vs voltage and the approximately 0V voltage are selectively applied to the first terminal of the capacitor C2 according to an operation of the transistors S1 and S2. When the transistor S2 is turned on, the capacitors C1 and C2 are respectively charged with the Vs/2 voltage by the diode D1.

In addition, a voltage that is lower than the Vs voltage corresponding to a half of a difference between the high level voltage Vs and the low level voltage −Vs is applied between the drain and the source of the turned-off transistor. Accordingly, the sustain discharge circuit 410′ according to the second exemplary embodiment of the present invention may alternately apply the Vs voltage and the −Vs voltage to the X electrode, and it may use the transistor having a low voltage.

While it has been assumed that the sustain discharge circuit 410′ is coupled to the X electrode and the approximately 0V voltage is applied to the Y electrode in FIG. 6 and FIG. 7, the sustain discharge circuit may be coupled to the Y electrode and the approximately 0V voltage may be applied to the X electrode.

In addition, when the source of the transistor S2 is coupled to a power source for supplying the −Vs/2 voltage in the circuit shown in FIG. 7, the sustain pulse alternately having the Vs/2 voltage and the −Vs/2 voltage may be applied to the X electrode. In this case, the sustain pulse having a reverse phase of the sustain pulse applied to the X electrode may be applied to the Y electrode.

While this invention has been described in connection with exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plurality of electrodes;
a first transistor having a first terminal coupled to a first power source for supplying a first voltage;
a second transistor having a first terminal coupled to a second terminal of the first transistor and a second terminal coupled to a second power source for supplying a second voltage;
a first capacitor adapted to be charged with a third voltage, and having a first terminal coupled to a node of the first transistor and of the second transistor;
a second capacitor adapted to be charged with a fourth voltage, and having a first terminal coupled to a second terminal of the first capacitor;
a charging path coupled between the first power source and a second terminal of the second capacitor;
an inductor, a third transistor, and a fourth transistor coupled in a series configuration, the series configuration having a fist terminal and a second terminal,
wherein the first terminal is coupled to the second terminal of the first capacitor and
wherein the second terminal is coupled to one or more of the first electrodes;
a fifth transistor coupled between the second terminal of the second capacitor and one or more of the electrodes; and
a sixth transistor coupled between one or more of the electrodes and the first terminal of the first capacitor.

2. The plasma display device of claim 1, wherein the third and fourth transistors are coupled to each other in a back-to-back manner.

3. The plasma display device of claim 2, wherein a first terminal of the inductor is coupled to the second terminal of the first capacitor, and the third and fourth transistors are coupled between a second terminal of the inductor and one or more of the electrodes.

4. The plasma display device of claim 1, wherein the charging path comprises a first diode having an anode coupled to the first power source and a cathode coupled to the second terminal of the second capacitor.

5. The plasma display device of claim 4, further comprising:
a second diode having an anode coupled to the second terminal of the inductor and a cathode coupled to the second terminal of the second capacitor; and
a third diode having a cathode coupled to the second terminal of the inductor and an anode coupled to the first terminal of the first capacitor.

6. The plasma display device of claim 1, wherein the third voltage and the fourth voltage are approximately equal.

7. The plasma display device of claim 1, wherein, when the second transistor is turned on, the first capacitor and the second capacitor are charged with the third voltage and the fourth voltage, respectively, and a sum of the third voltage and the fourth voltage corresponds to a difference between the first voltage and the second voltage.

8. The plasma display device of claim 1, further comprising:
a controller adapted to:
set the second transistor and the sixth transistor to be turned on during a first mode;
set the second transistor and the third transistor to be turned on during a second mode;
set the second transistor and the fifth transistor to be turned on during a third mode;
set the first transistor and the third transistor to be turned on during a fourth mode;
set the first transistor and the fifth transistor to be turned on during a fifth mode;
set the first transistor and the fourth transistor to be turned on during a sixth mode;
set the second transistor and the fifth transistor to be turned on during a seventh mode; and
set the second transistor and the fourth transistor to be turned on during an eighth mode.

9. The plasma display device of claim 1, wherein the second voltage is a ground voltage and the first voltage is a voltage greater than ground voltage.

10. The plasma display device of claim 1, wherein the first voltage is a ground voltage and the second voltage is a negative voltage.

11. A driving method for driving a plasma display device having a first electrode and a second electrode, the method comprising:
increasing a voltage at the first electrode, by supplying energy stored in a first capacitor adapted to be charged with a first voltage to the first electrode through an inductor coupled to the first electrode;
applying a third voltage corresponding to a sum of the first voltage and a second voltage to the first electrode through the first capacitor and a second capacitor adapted to be charged with the second voltage;
increasing the voltage at the first electrode, by supplying a fourth voltage from a first power source, and the energy stored in the first capacitor, to the first electrode through the inductor;
applying a fifth voltage corresponding to a sum of the third voltage and the fourth voltage to the first electrode through the first power source and the first capacitor and the second capacitor;
decreasing the voltage at the first electrode by recovering an energy stored in the first electrode to the first capacitor and the first power source through the inductor;
applying the third voltage to the first electrode through the first capacitor and the second capacitor;
decreasing the voltage at the first electrode by recovering the energy stored in the first electrode to the first capacitor through the inductor; and
applying a sixth voltage that is lower than the fourth voltage to the first electrode.

12. The driving method of claim 11, wherein applying the sixth voltage to the first electrode comprises respectively charging the first capacitor and the second capacitor with the first voltage and the second voltage through the first power source.

13. The driving method of claim 11, wherein applying the third voltage to the first electrode comprises recovering energy remaining in the inductor and supplying it to the first and second capacitors.

14. The driving method of claim 11, wherein the first voltage and the second voltage are approximately equal to one another, and the third voltage and the fourth voltage are approximately equal to one another.

15. The driving method of claim 11, wherein a difference between the fourth voltage and the sixth voltage corresponds to a half of a difference between the first voltage and the sixth voltage.

16. A driving apparatus for driving a plasma display device comprising a first electrode and a second electrode, the driving apparatus comprising:
a first capacitor having a first terminal and a second terminal and adapted to be charged with a first capacitor voltage;
a second capacitor having a first terminal and a second terminal and adapted to be charged with a second capacitor voltage, and having the first terminal coupled to a first terminal of the first capacitor;
a first driving apparatus transistor coupled between the second terminal of the first capacitor and the first electrode;
a second driving apparatus transistor coupled between the second terminal of the second capacitor and the first electrode;
an inductor coupled between a node of the first capacitor and the second capacitor and the first electrode;
a first resonance path formed between the node of the first capacitor and the second capacitor and the first electrode, and adapted to increase a voltage at the first electrode by a resonance;
a second resonance path formed between the node of the first capacitor and the second capacitor and the first electrode, and adapted to decrease the voltage at the first electrode by the resonance; and
a switching unit adapted to selectively apply a first driving voltage and a second driving voltage that is lower than the first driving voltage to the second terminal of the second capacitor.

17. The driving apparatus of claim 16,
wherein the first resonance path comprises a third driving apparatus transistor coupled in series to the inductor, and
wherein the second resonance path comprises a fourth driving apparatus transistor coupled in series to the inductor and the third driving apparatus transistor, and a source of the third driving apparatus transistor and the source of the fourth driving apparatus transistor are coupled to each other.

18. The driving apparatus of claim 17, wherein the first resonance path is formed by the third driving apparatus transistor and a body diode of the fourth driving apparatus transistor, and the second resonance path is formed by the fourth driving apparatus transistor and a body diode of the third driving apparatus transistor.

19. The driving apparatus of claim 16, wherein:
the voltage at the first electrode is increased through the first resonance path while the second driving voltage is applied to the second terminal of the second capacitor;
a fifth voltage corresponding to a sum of the second driving voltage, the first capacitor voltage, and the second capacitor voltage is applied to the first electrode by turning on the first driving apparatus transistor while the second driving voltage is applied to the second terminal of the second capacitor;
the voltage at the first electrode is increased through the first resonance path while the first driving voltage is applied to the second terminal of the second capacitor;
a sixth voltage corresponding to a sum of the first driving voltage, the first capacitor voltage, and the second capacitor voltage is applied to the first electrode by turning on the first driving apparatus transistor while the first driving voltage is applied to the second terminal of the second capacitor;
the voltage at the first electrode is decreased through the second resonance path while the first driving voltage is applied to the second terminal of the second capacitor;
the first capacitor voltage is applied to the first electrode by turning on the first driving apparatus transistor while the second driving voltage is applied to the second terminal of the second capacitor;
the voltage at the first electrode is decreased through the second resonance path while the second driving voltage is applied to the second terminal of the second capacitor; and
the second driving voltage is applied to the first electrode by turning on the second driving apparatus transistor while the second driving voltage is applied to the second terminal of the second capacitor.

20. The driving apparatus of claim 16, wherein the first capacitor voltage and the second capacitor voltage are approximately equal to one another, and a sum of the first capacitor voltage and the second capacitor voltage is approximately equal to a difference between the third driving voltage and the fourth driving voltage.
